(19) United States
(12) Patent Application Publication
(10) Pub. No.: US 2007/0247394 A1
(43) Pub. Date: Oct. 25, 2007

(54) Display menu allowing better accessibility in a limited space

(76) Inventor: Corydon J. Boyan, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/407,644

(22) Filed: Apr. 20, 2006

(51) Int. Cl. G09G 1/14

(52) U.S. Cl. 345/23

(57) ABSTRACT

A parent menu in the display of an electronic device includes a conditional branch key. The conditional branch key is associated with an action and a branch menu. When the conditional branch key is selected a first time, the action is performed by the electronic device and a visual characteristic of the conditional branch key is visually altered. When the conditional branch key is selected a second time, the branch menu replaces the parent menu in the display.

### BACKGROUND

Displays on electronic devices such as measurement instruments, audio/video/game appliances, cell phones, portable audio/video/game devices, personal electronic organizers, etc. are typically small and limited in what can be shown on the display. These constraints often result in display menus that are non-intuitive and require many keystrokes to navigate.

Therefore, there is a need to simplify menu navigation and maximize the usage of limited display space.

### BRIEF DESCRIPTION OF THE DRAWINGS

FIG. 1 shows an electronic device having a display in which the present invention may be practiced.

FIGS. 2A-2D show prior art trigger menus in the display of a spectrum analyzer.

FIGS. 3A-3C demonstrate the use of conditional branch keys in the display of a spectrum analyzer.

FIG. 4 is a flowchart which describes the operation of the conditional branch key and the conditional branch indicator.

### DETAILED DESCRIPTION

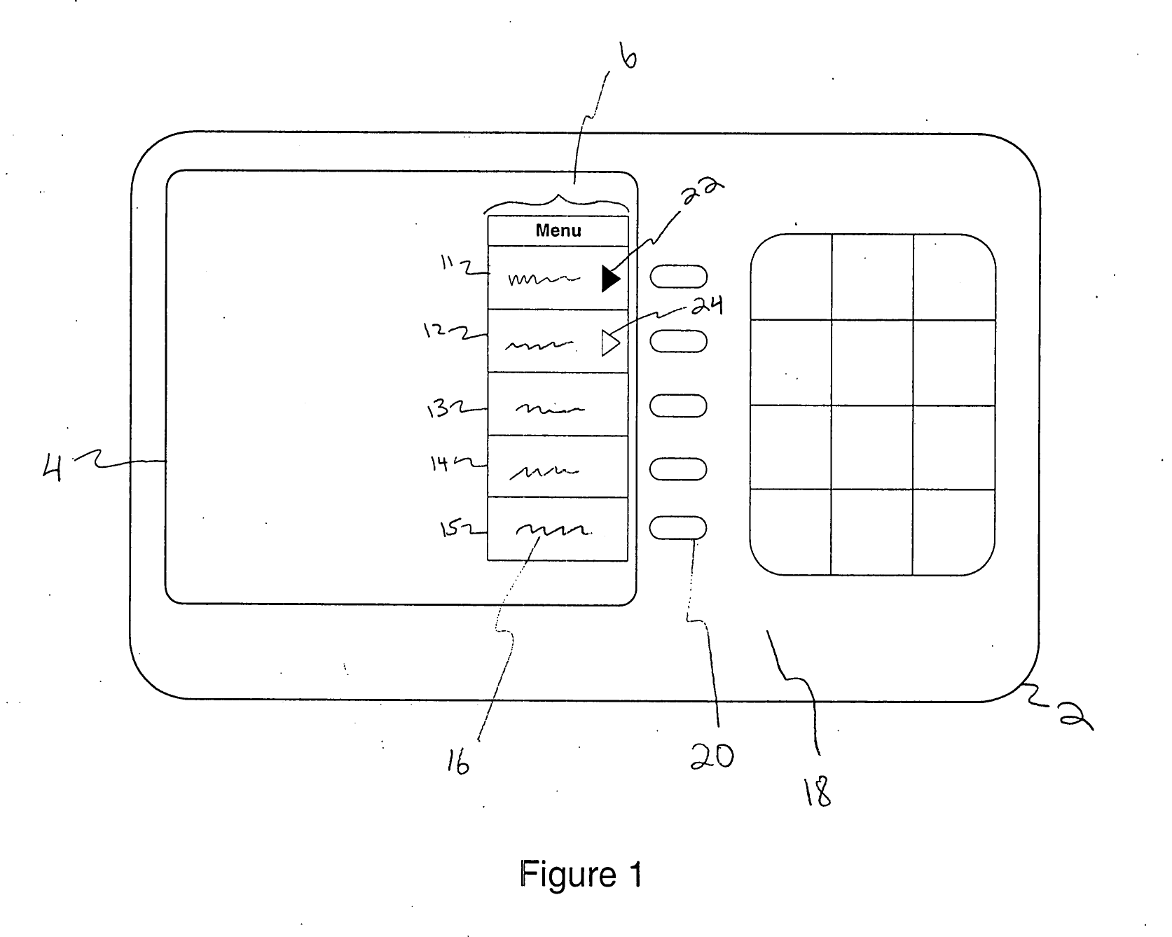

FIG. 1 shows an electronic device 2 having a display 4 in which the present invention may be practiced. The display 4 is typically a monitor (such as a cathode ray tube, liquid crystal display, etc.) on which information about the electronic device 2 is shown. The actual information shown will depend on the electronic device 2 in which the display 4 is used. The display 4 includes a menu 6. The menu 6 is a collection of option keys 11-15. An option key is a virtual button in the menu 6 which a user of the electronic device 2 can select. The menu 6 typically groups option keys together by similar function. A label 16 on each option key describes the action that will be performed by the electronic device when the option key is selected. The labels and the action represented by each option key can change during the operation of the electronic device 2, depending on the state or mode that the electronic device 2 is in. The electronic device 2 also includes a control panel 18 through which the user may enter input and control the electronic device 2.

The option keys 11-15 may be selected in a variety of ways. The manner in which the option key is selected is not crucial to the present invention. For example, the control panel 18 may include buttons 20, such that pushing a button 20 selects the closest option key. Or, the display 4 might be a touch-sensitive monitor, in which case an option key is selected by simply touching it. Alternatively, the electronic device 2 may have a mouse connected to it for navigating the display 4, in which case an option key is selected by using the mouse to click on it.

any different kinds of option keys exist. Some option keys simply perform an action when selected. Other option keys, in addition to performing an action, also display information such as configuration values.

Option key 11 is an active branch key, and includes an active branch indicator 22, shown here as a solid arrow symbol pointing to the right. When an option key has an active branch indicator 22 showing, selecting the option key will bring up a branch menu to replace the menu that was originally showing (the “parent menu”).

Option key 12 is a conditional branch key made according to the present invention. Option key 12 includes a conditional branch indicator 24, shown here as a hollow arrow symbol pointing to the right. Conditional branch keys serve dual purposes. Selecting a conditional branch key a first time will cause the electronic device to perform a first action. The conditional branch indicator 24 will also be changed into an active branch indicator 22. Selecting the conditional branch key a subsequent time will bring up a branch menu to replace the menu currently showing.

The operation of the conditional branch key can be better understood by contrasting it with the prior art. For the sake of discussion, all examples hereinafter will assume that the electronic device 2 is a spectrum analyzer. However, it should be understood that the present invention is not limited to spectrum analyzers.

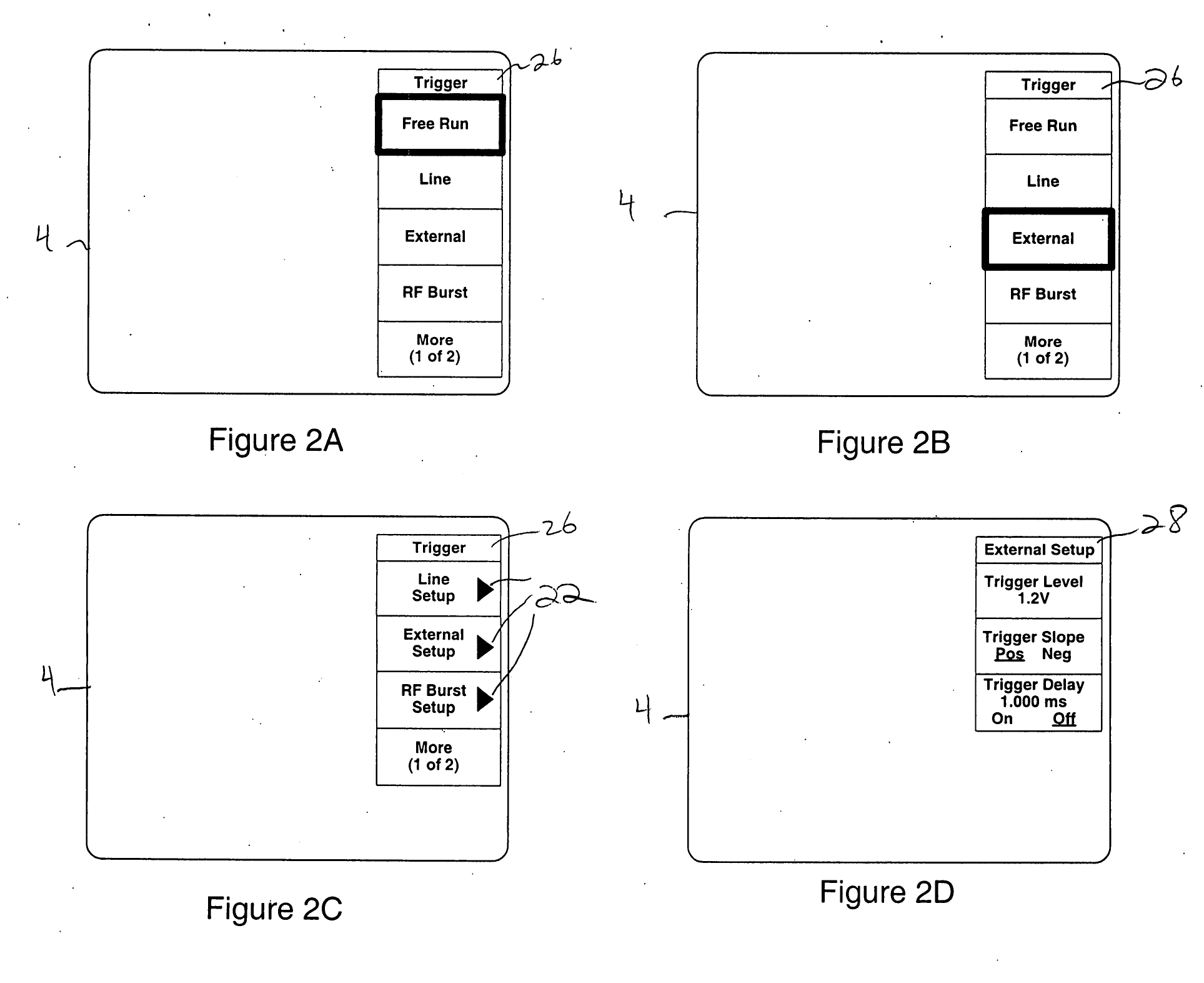

FIG. 2A shows prior art trigger menu 26 in the display 4 of a spectrum analyzer. A trigger is a user-defined event that must happen before the spectrum analyzer can perform certain functions on an input signal, such as displaying the input signal, performing a measurement on the input signal, or beginning data acquisition. There are five option keys in the trigger menu 26: “Free Run”, “Line”, “External”, “RF Burst”, and “More (1 of 2)”. The option key “Free Run” (which causes the spectrum analyzer to acquire data automatically) is currently selected, as indicated by its bold outline. The “Line”, “External”, and “RF Burst” option keys each represent a different type of trigger that is available to the user. The trigger menu 26 has more option keys than can be shown in the space available, so the trigger menu 26 is divided into two pages. Only the first page is currently showing. Selecting the option key “More (1 of 2)” will bring up the second page with the remaining option keys. None of the option keys are currently selected.

Suppose the user would like to have the spectrum analyzer trigger off a signal from an external line (not shown). This is accomplished by simply selecting the option key “External”. The functions of the other trigger option keys do not need to be explained in detail, as it is not necessary to understand the present invention.

FIG. 2B shows the trigger menu after the option key “External” has been selected. The option key “External” is outlined in bold to show that it has been selected, and the spectrum analyzer is now configured to trigger off of the external line.

Suppose the user would now like to configure the external trigger. The setup for the external trigger is on the second page of the trigger menu 26 and is accessed by selecting the “More (1 of 2)” option key.

FIG. 2C shows the trigger menu 26 after the “More (1 of 2)” option key has been selected, replacing the first page of the two-page trigger menu with the second page. The new option keys are now “Line Setup”, “External Setup”, and “RF Burst Setup”. Each of these option keys has an active branch indicator 22. Selecting one of these active branch keys will bring up a branch menu with setup options for the indicated trigger. When the user selects the active branch key “External Setup”, the branch menu for configuring the external trigger will appear.

FIG. 2D shows the External Setup branch menu 28, after the active branch key “External Setup” was selected in the previous trigger menu 26. Now, several option keys showing different parameters for the external trigger are available for the user to adjust as desired: “Trigger Level”, “Trigger Slope”, and “Trigger Delay”. These option keys also display information regarding the configurations. For example, the “Trigger Level” option key displays the voltage for the external trigger.

As this example illustrates, many keystrokes are required by the user to navigate the prior art menus and achieve the desired results. The process can be simplified by the use of conditional branch keys, which are explained below.

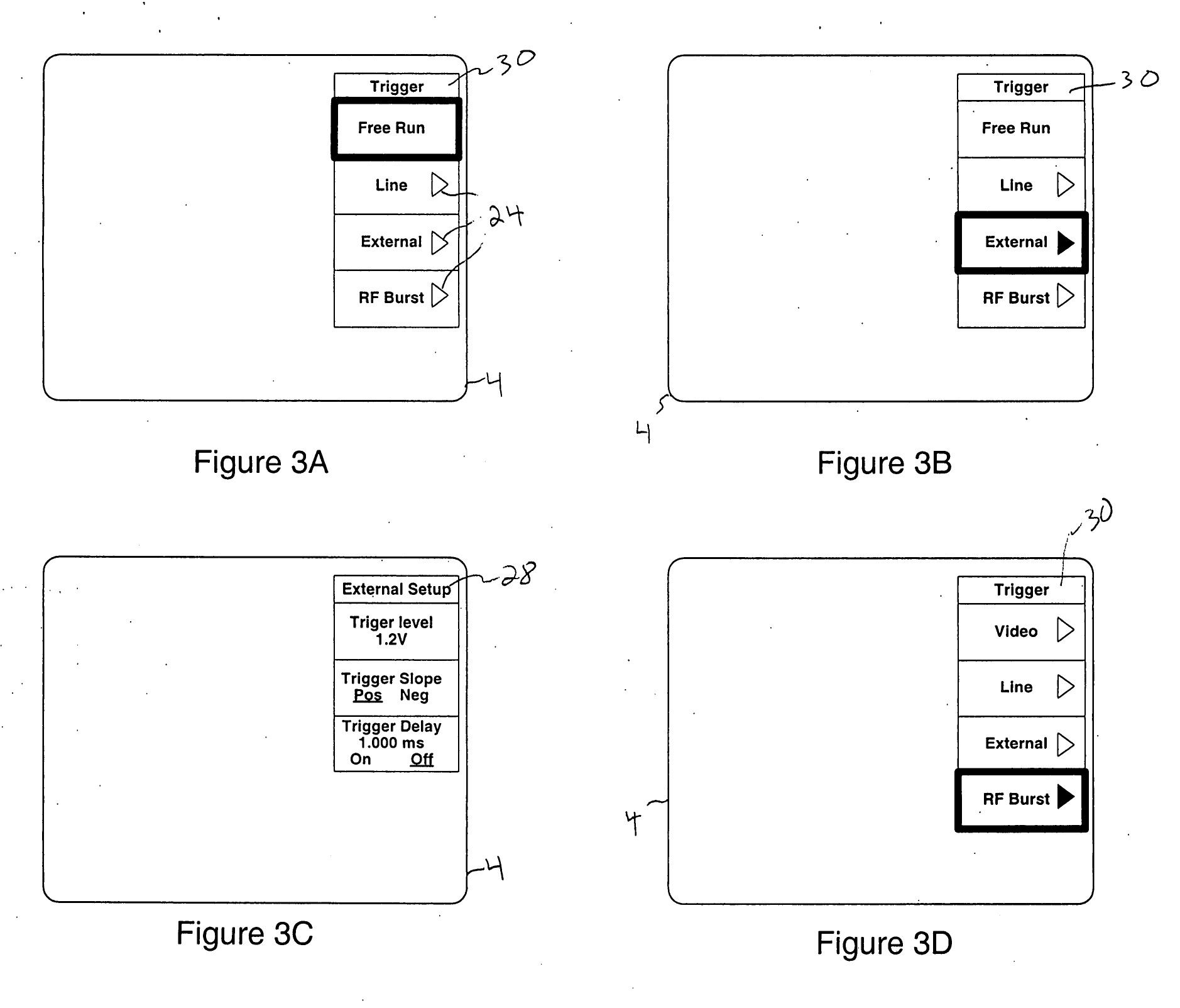

FIG. 3A shows a trigger menu 30 having four option keys: “Free Run”, “Line”, “External”, and “RF Burst”. Three of these option keys also have a conditional branch indicator 24, shown here as a hollow triangle pointing to the right. The conditional branch indicator 24 tells the user that a branch menu exists for this option key. The option key “Free Run” is currently selected, as indicated by its bold outline.

Suppose that a user would again like to use the external trigger in the spectrum analyzer. This is accomplished by selecting the conditional branch key “External” a first time. FIG. 3B shows the trigger menu after a user has selected the conditional branch key “External”, as indicated by its bold outline. Notice that the conditional branch indicator 24 has changed into an active branch indicator 22, a solid triangle pointing to the right. If the option key “External” is selected again while the active branch indicator is showing, the “External Setup” branch menu will appear and replace the trigger menu 30.

FIG. 3C shows the External Setup branch menu 28, which replaces the trigger menu 30 after the option key “External” was selected from the previous trigger menu 30. Now the user can edit the external trigger parameters as desired. This is the same menu that was shown in FIG. 2D, but it took one less keystroke by the user to reach this menu. The conditional branch indicator allows two actions to be combined into a single option key. In this example, the actions of selecting the external trigger and configuring the external trigger are combined and accessible through a single conditional branch key “External”.

Now, refer back to FIG. 3A. In this example, the option keys “Free Run”, “Line”, “External”, and “RF Burst” in the trigger menu 30 are mutually exclusive selections (similar to buttons for different channels on a radio), allowing the spectrum analyzer to select only a single trigger at a time. Suppose again that the user wants to trigger off of the external line. After selecting the option key “External”, the trigger menu would again look like FIG. 3B. But, suppose the user wants to change the trigger to “RF Burst” without configuring the external trigger. When the user selects “RF Burst”, the active branch indicator (solid arrow symbol) on the “External” option key reverts back to a conditional branch indicator (hollow arrow symbol), and the conditional branch indicator on the “RF Burst” option key changes into an active branch indicator, as shown in FIG. 3D. The conditional branch keys do not have to be mutually exclusive selections, however.

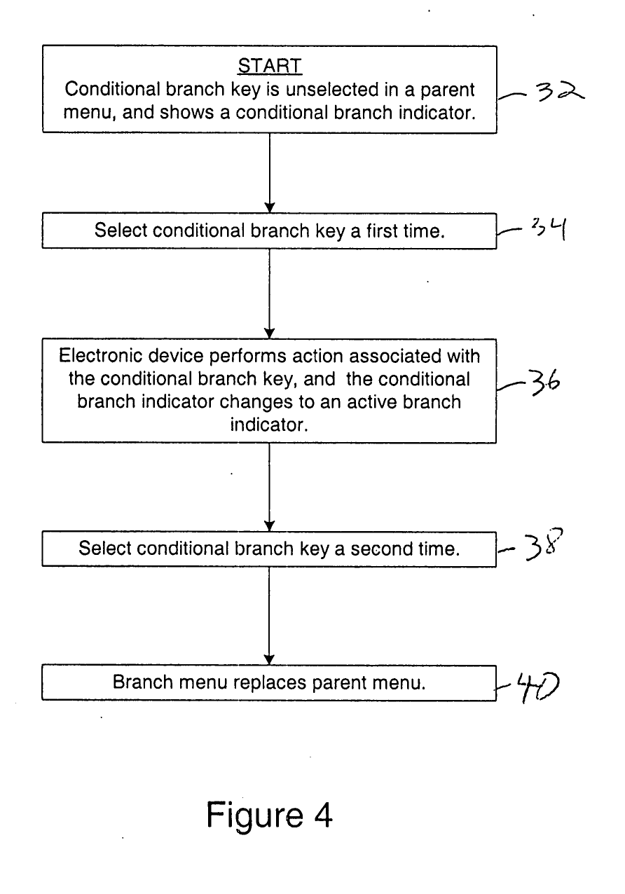

FIG. 4 is a flowchart which describes the operation of the conditional branch key and the conditional branch indicator in more general terms. Initially, the conditional branch key is unselected in a parent menu (step 32). The conditional branch key displays a conditional branch indicator 24, and is associated with both an action of the electronic device and a branch menu. Next, the user to selects the conditional branch key a first time (step 34). The action associated with the conditional branch key is performed, and the conditional branch indicator 24 changes into an active branch indicator 22 (step 36). Then the user selects the conditional branch key a second time (step 38). Finally, the branch menu replaces the parent menu in the display (step 40). The branch menu may also be a parent menu itself, and contain more conditional branch keys.

The user may find that a conditional branch key is easier and more intuitive to use when its associated branch menu displays options that are related to the action performed by the conditional branch key. For instance, in the external trigger example of FIG. 3A-C, the action associated with the “External” conditional branch key was triggering off of the external line. The branch menu associated with the “External” conditional branch key brought up options for configuring the external trigger.

In the examples shown above, the conditional branch indicator 24 is a hollow arrow symbol that changes into a solid arrow symbol when the conditional branch key is selected. Other symbols can be used as well, such as other geometric shapes, graphic icons, etc. Other characteristics of the symbols can be altered, such as their shape, size, position, color, etc. The conditional branch indicator 24 does not need to be limited to symbols on the conditional branch key, either. The conditional branch indicator 24 can be any characteristic of the conditional branch key that can be visually altered, such as its shape, size, position, color, etc. Furthermore, the conditional branch indicator 24 may even be located somewhere outside of the conditional branch key. For example, in situations where the option keys are selected using proximate buttons (e.g. buttons 20 in FIG. 1), the conditional branch indicator might be an embedded, color-changing light emitting diode located on those buttons themselves. Generally, the conditional branch indicator should bear some resemblance to the active branch indicator so that the user will recognize the relationship between the conditional branch indicator and the availability of a branch menu. For example, the conditional branch indicator 24 is the same shape as the active branch indicator 22 in FIG. 1. The only difference is that the active branch indicator 22 is solid, whereas the conditional branch indicator 24 is hollow.

Implementing the conditional branch key and the conditional branch indicator 24 can be done using any programming language suitable for designing graphical user interfaces.

I claim:

1. An apparatus, comprising
a display for an electronic device;
a parent menu in the display; and
a conditional branch key in the parent menu having a visual characteristic that indicates an action and a branch menu are associated with the conditional branch key, such that,
when the conditional branch key is selected a first time, the action is performed by the electronic device and the visual characteristic is visually altered.

2. An apparatus as in claim 1, wherein
when the conditional branch key is selected a second time, the branch menu replaces the parent menu in the display.

3. An apparatus as in claim 2, wherein
the visual characteristic is a first symbol on the conditional branch key.

4. An apparatus as in claim 3, wherein
when the conditional branch key is selected a first time, the first symbol changes into a second symbol that resembles the first symbol in appearance.

5. An apparatus as in claim 4, wherein the first symbol is a hollow arrow symbol and the second symbol is a solid arrow symbol.

6. An apparatus as in claim 2, further comprising
a physical button in the electronic device, proximate to the conditional branch key, for selecting the conditional branch key.

7. An apparatus as in claim 2, further comprising
at least one additional conditional branch key in the parent menu, wherein the conditional branch key and the additional conditional branch key are mutually exclusive selections.

8. An apparatus as in claim 7, wherein the second selection of the conditional branch key must occur consecutive to the first selection of the conditional branch key for the branch menu to replace the parent menu in display.

9. An apparatus as in claim 2, wherein the electronic device is a spectrum analyzer.

10. An apparatus, comprising
a display for an electronic device;
a parent menu having a conditional branch key in the display;
a conditional branch indicator corresponding to the conditional branch key, indicating that an action and a branch menu are associated with the conditional branch key, such that,
when the conditional branch key is selected a first time, the action is performed by the electronic device and the conditional branch indicator changes into an active branch indicator.

11. An apparatus as in claim 10, wherein
when the conditional branch key is selected a second time, the branch menu replaces the parent menu in the display.

12. An apparatus as in claim 11, wherein the conditional branch indicator is a symbol on the conditional branch key.

13. An apparatus as in claim 11, further comprising
a physical button in the electronic device proximate to the conditional branch key for selecting the conditional branch key, wherein the conditional branch indicator is located on the physical button.

14. A method for operating the display of an electronic device, comprising
displaying a conditional branch key in a parent menu in the display;
associating an action of the electronic device and a branch menu with the conditional branch key;
performing the action and altering a visual characteristic of the conditional branch key when the conditional branch key is selected a first time;

15. A method as in claim 14, further comprising
replacing the parent menu in a display with the branch menu when the conditional branch key is selected a second time.

16. A method as in claim 15, wherein
the visual characteristic is a symbol on the conditional branch key.

17. A method as in claim 16, wherein
the visual characteristic is a hollow arrow symbol that is visually altered into a solid arrow symbol.

18. A method as in claim 15, further comprising
selecting a physical button in the electronic device to select the conditional branch key, wherein the button is proximate to the conditional branch key.

19. A method as in claim 15, further comprising
displaying at least one additional conditional branch key in the parent menu, wherein the conditional branch key and the additional conditional branch key are mutually exclusive selections.

20. A method as in claim 19, wherein the second selection of the conditional branch key must occur consecutive to the first selection of the conditional branch key for the branch menu to replace the parent menu in display.
